(19) United States
(12) Patent Application Publication
(10) Pub. No.: US 2006/0169112 A1
(43) Pub. Date: Aug. 3, 2006

(54) Cutting blade for cutting sheet material

(76) Inventor: Armin C. Frank, Blue Bell, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/343,197

(22) Filed: Jan. 30, 2006

Related U.S. Application Data
(60) Provisional application No. 60/647,876, filed on Jan. 28, 2005.

(51) Int. Cl. B26D 1/00

(52) U.S. Cl. 83/13; 30/346

(57) ABSTRACT

A cutting blade (10) for safely and effectively cutting sheet material is provided. The cutting blade is particularly suited for cutting sheet material such as foil wrap from a roll. The cutting blade includes a plurality of microteeth (52) that allow the cutting blade to cut foil while minimizing fine pieces of foil material that may be severed when cutting foil wrap.

### PRIORITY CLAIM

This application claims priority to U.S. Provisional Patent Application No. 60/647,876, filed Jan. 28, 2005, which in hereby incorporated by reference.

### FIELD OF THE INVENTION

The present invention relates to cutting blades for cutting sheet wrapping materials. More specifically, the present invention relates to cutting blades used to sever foil, plastic or other sheet wrapping material that is dispensed from a roll package.

### BACKGROUND OF THE INVENTION

Sheet wrapping material is widely used throughout the food industry to wrap or cover various food products. The plastic film or foil sheet wrapping material is typically dispensed from a roll contained in a box. Whenever a piece of sheet wrapping material is required, the length of the material is withdrawn from the box and cut to length by a cutting blade that is attached to the front panel of the box.

The cutting blade commonly used for many years has been a thin metallic saw-toothed blade having cutting points extending along the exposed edge of the blade. Although the points of the cutting blade can nick or cut the user, the real risk to the user results from the cutting blade being made from a thin strip of metal. Just as a piece of paper can cause a cut, the edge of a thin strip of metal, with or without saw-toothed points, can cut.

In recent years cutting blades have been produced to safely cut sheet materials. The cutting blades have proven to effectively and safely cut plastic film materials. However, the known cutting blades have provided either ineffective or undesirable results when cutting foil material. For instance, some safety cutting blades that are able to cut foil material, also produce small shreds of foil material when cutting the foil material. The small shreds of foil material are typically unacceptable in the food industry since the shreds of foil material may readily mix with the food being wrapped. Accordingly there is a need for a cutting blade that safely and effectively cuts foil material without producing unacceptable shreds of foil material.

### SUMMARY OF THE INVENTION

In the present invention, a cutting blade for cutting sheet wrapping material is provided which not only reduces the risk of inadvertent cuts to the users or other handlers of the blade but also effectively cuts both foil and plastic material.

Accordingly, a cutting blade is provided that is configured to safely cut sheet material, such as foil wrap without producing small pieces of foil, commonly referred to as fines.

Further, the invention provides a cutting blade that includes a longitudinally elongated web having a length, and a generally vertical leg connected with the web, projecting downwardly from the web for connecting the blade to a substrate. The cutting blade includes a row of surface irregularities extending along the length of the web. The surface irregularities may be a row of teeth that project upwardly from the web less than approximately 0.015″, and preferably at least approximately 0.010″. In addition, the row of teeth may be positioned along an edge of the web that extends along the length of the blade.

A cutting blade for cutting sheet material is also provided that comprises a row of teeth wherein each tooth comprises a cutting element that projects toward another portion of the tooth, such as a central portion of the tooth. The cutting blade may also include an elongated web and a leg projecting downwardly from the web. The leg may be configured for attaching the cutting blade to a substrate.

A method for cutting sheet material is also provided. According to the method, a cutting blade is provided having a generally horizontal longitudinally elongated web, and elongated edge along the length of a side of the web, and a row of surface irregularities extending along the elongated edge. The surface irregularities may be formed so that the surface irregularities project upwardly from the web approximately 0.005″ to approximately 0.020″. The cutting blade is attached to a substrate, and a length of sheet material is pulled over the cutting blade from a roll of sheet material. The sheet material is then pulled against the surface irregularities and the elongated edge to cut the length of sheet material from the roll.

A method for producing a cutting blade is also provided. An elongated strip of metal is formed and a forming element is used to form a plurality of teeth in a row in the strip of metal. The row of teeth is formed by displacing a tip of the forming element toward the metal strip so that the tip deforms the metal to form a protrusion. The forming tool may be displaced into the metal until a portion of the protrusion cracks. In addition, the displacement of the tip may be limited so that the end of the protrusion protrudes from the metal strip further than the tip of the forming tool.

### BRIEF DESCRIPTION OF THE DRAWINGS

The foregoing summary and the following detailed description of the preferred embodiments of the present invention will be best understood when read in conjunction with the appended drawings, in which:

FIG. 1 is a perspective view of a dispenser box having a cutting blade incorporating the present invention;

FIG. 2 is a fragmentary sectional view taken on the line 2-2 in FIG. 1 showing in broken lines the wrapping material dispensed from the box;

FIG. 3 is an enlarged side view of the cutting blade of FIG. 1 removed from the box;

FIG. 4 is an enlarged fragmentary perspective view of the cutting blade of FIG. 1 removed from the box with the size of the teeth exaggerated;

FIG. 5 is an enlarged fragmentary front elevational view of a portion of the cutting blade of FIG. 1; and

FIG. 6 is an enlarged plan view of a front tooth of the cutting blade of FIG. 1.

### DETAILED DESCRIPTION OF THE INVENTION

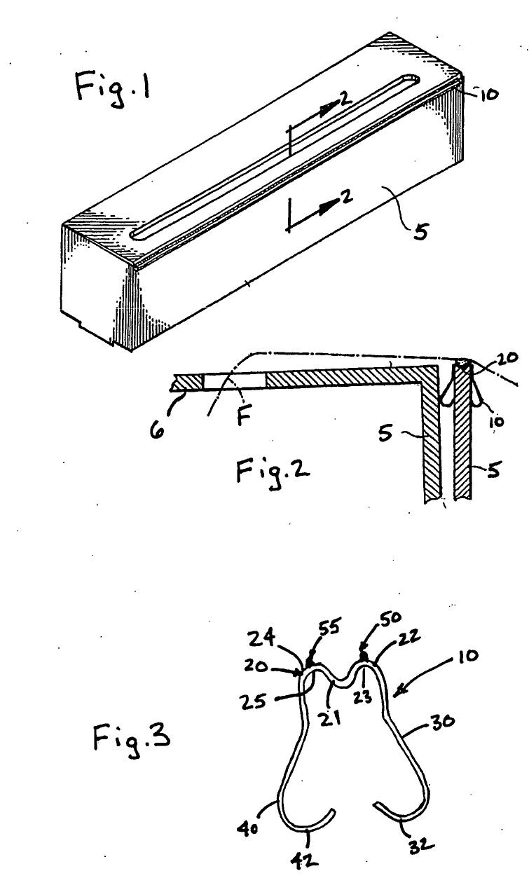

Referring now to the drawings in general and FIGS. 1-6 specifically, there is shown a cutting blade 10 used for cutting sheet wrapping materials such as plastic film F or other sheet wrapping material. In FIGS. 1-2, the cutting blade 10 is shown in connection with a dispensing box 5. A roll of foil F or other sheet wrapping material is contained within the box 5. A length of foil is pulled off the roll and is pulled against the cutting blade 10 to cut the foil from the roll.

As shown in FIGS. 2-3, the cutting blade may be configured in a generally U-shaped channel that slips over the front edge of the box. The box 5 has a lid 6 with a flap which is designed to slip behind the front panel of the box. In operation, the user draws a length of the plastic film or other sheet wrapping material from the roll in the dispenser box, as shown at F in FIG. 2, and cuts the material to length by pulling the material angularly either upward or downward and outward over the cutting blade 10. To ensure that the entire width of the plastic film or other sheet wrapping material is cut rather than torn, it is desirable for the cutting blade 10 to be at least as long as the width of the roll of plastic film or other sheet wrapping material in the dispenser box, and that the cutting teeth extend throughout the length of the blade 10.

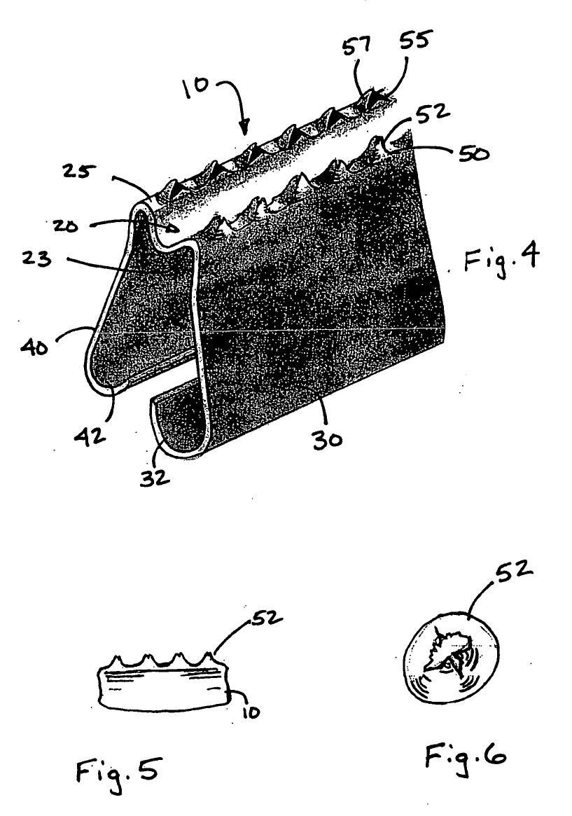

The cutting blade 10 is formed from a continuous thin band. The band is bent into a generally U-shape configuration as shown in FIGS. 2 and 4, producing a central web 20 at the base of the U and legs 30, 40 depending downwardly in the same direction from the web 45 to form the legs of the U. At the free extremity of each leg 30, 40, an end flap 32, 42 is reversely curved inwardly into the interior of the U-shaped formation. The end flap 32, 42 of each leg 30, 40 terminates in a gripper edge. The gripper edges provide a good grip on the front panel of the box when the cutter blade is slipped over the free edge of the panel.

As shown in FIGS. 3 and 4, the medial portion of the web 21 extends between shoulders 22,24 which define the width of the base web. The shoulders are quarter-cylinder and have a radius sufficient to provide clearance so that the film may contact the teeth when pulled downward over the cutting blade. The medial portion of the web should be wide enough to provide support in the event that the user inadvertently comes in contact with the teeth.

Each of the legs 30, 40 extends from its associated shoulder 22, 24 past an obtuse bend line to a reverse curve that enables the end flaps to form an acute angle, for example 45°, with the center plane of the cutter blade. The curves of the two legs are bent toward each other, and in the illustrated embodiment have approximately the same radius of curvature as the shoulders and each other. Above the bend line, the upper portion of the legs are parallel to one another and to the center plane, so as to form with the base web a generally rectangular pocket to receive the upper edge of a panel onto which the blade is mounted. Below the bend lines the legs diverge downwardly and outwardly. The terminal edges 32, 42 of the legs 30, 40 are spaced apart within the center of the U-shaped cutting blade by a spacing that is smaller than the width of the base web 20 of the cutting blade 10.

A line of surface irregularities 50 is formed in the cutting blade adjacent the front edge 22 of the cutting blade 10. The surface irregularities assist in the cutting of the sheet material F as the sheet material is pulled against the front edge 22. In the present instance, the line of surface irregularities 50 is a row of microteeth 52. The microteeth 52 are preferably quite short. In the present instance the microteeth project upwardly from the web less than 0.020″. More specifically the microteeth project upwardly from the web between 0.005″ and 0.015″. In the present instance the microteeth are between approximately 0.010″ and approximately 0.012″. Note that in FIG. 4 the microteeth are not drawn to scale. Instead, the teeth are drawn as enlarged relative to the size of the cutting blade, to better illustrate the details of the teeth.

Referring to FIGS. 4-6, the microteeth 52 maybe formed in a variety of configurations. In the present embodiment, each microtooth 52 is a generally conical or pyramidal projection protruding upwardly from the surface of the web 20. The tip of the projection is fractured to form a cutting surface. In addition, the microteeth 52 are formed so that the cutting surfaces of the microteeth are disposed transverse the longitudinal axis of the web 20.

The present embodiment further includes a second line of surface irregularities 55 adjacent the rearward edge 24 of the cutting blade 10. The rearward surface irregularities 55 are also a line of microteeth 57 configured substantially similarly to the microteeth 52. In addition, in the present instance the microteeth 57 are formed so that the cutting surfaces of the microteeth oppose the cutting surfaces of the front row of microteeth 52. In this way, the cutting blade is generally symmetric so that the blade can be installed with either edge away from the roll of film. Further, since the blade has teeth on the front and rearward edges, the sheet material can be cut by either pulling the material upward and against the rearward edge 24 or by pulling the material downward against the forward edge 22.

As shown in FIGS. 3 and 4, the front row 50 of microteeth 52 are positioned along the front edge 22 of the cutting blade 10. Similarly, the rear row 55 of microteeth 57 are positioned along the rearward edge 24 of the cutting blade 10. More specifically, in the present instance, the web 20 protrudes upwardly adjacent the front edge 22 forming a ridge that extends along the length of the cutting blade 10. The front row 50 of microteeth 52 are longitudinally aligned, projecting upwardly from the ridge at the front edge 22 of the cutting blade. Similarly the rear row 55 of microteeth 57 are longitudinally aligned, and project upwardly from a ridge that extends along the rear edge 24 of the cutting blade.

The pitch P of the microteeth is between 12 and 22 teeth per inch. By limiting the height of the teeth, skin which is in contact with the teeth will tend to bend around the teeth and come to rest on, and be supported by, the web surface 20. Only excessive pressure combined with motion across the teeth can cause a cut or abrasion which in any case is limited to the depth of the teeth.

The cutter blade of the present invention is designed so that it may be attached by the end user or by the manufacturer of the packaged sheet wrapping material. Configured as shown in FIG. 3, the user can slip the cutting blade 10 over a front panel of the box 5 which is typically a piece of cardboard or corrugated board having a free edge. Typically, the user will simply push, the cutting blade 10 over the front panel of a dispenser box 5 until the underside of the web 20 seats against the free edge of the box. The inwardly-curved flaps 32, 42 of the cutting blade 10 tend to grip the cardboard so that the cutting blade 10 resists being removed from the cardboard.

Although the cutting blade has been described as having a pair of legs so that an end user can slip the blade onto a box, the blade may be formed in a number of alternate configuration so that it can be positioned adjacent the sheet wrapping material. For instance, the blade may be staked onto a separate piece of material, such as a panel of cardboard, and the panel may be inserted into the box. Prior to use, the user can simply place the cardboard and attached blade assembly in the front of the box. In such a configuration, rather than having a pair of legs, the cutting blade may have a single leg that includes a number of barbs for attaching the blade to the cardboard. Accordingly, the connection utilized to attach the blade to the box or onto a separate substrate can vary. Specifically, the cutting blade can utilize any connection that allows the blade to be positioned adjacent the roll of material and retained in position during use.

The cutting blade is produced as follows. A thin band of material, preferably a metal, is roll formed to produce a generally U-shaped channel, having a pair of downwardly extending legs 30, 40 connected to a generally flat web 20. The legs 30, 40 are roll formed to create the flared legs and the gripping end portions as shown in FIG. 3. The rows of microteeth 50, 55 are then formed in the blade 10.

The microteeth 52, 57 maybe formed by punching through the web 20. However, the present embodiment, the microteeth 52, 57 are formed by roll forming. More specifically, a roll forming tool having a tooth forming element engages the web 20 as the blade 10 is conveyed over the roll forming tool. The tooth forming element displaces the web material upwardly thereby producing a protrusion. In addition, during the formation of the teeth, the forward edge of the web 20 is displaced upwardly forming the ridge at the front edge 22 of the cutting blade 10. The configuration of the microteeth may be varied by altering the depth that the tooth forming element projects into the web. If the tooth forming tool element projects into the web a relatively shallow amount, the teeth formed are simply protrusions from the surface of the web. If the roll forming tool projects further into the web, the further deformation of the web material causes the tips of the protrusions to crack or fracture, thereby forming the cutting surfaces described above.

More specifically, preferably the tool for forming the microteeth projects into the web displacing the web upwardly to form a protrusion. In the present instance, the forming tool comprises elements having sharply pointed conical or pyramidal shaped tips. Therefore, as a forming element is displaced into the web, the forming element forms a conical or pyramidal shaped protrusion. When making the known safety cutting blades, the forming elements are displaced into the web so that the tool bursts through the web, thereby forming a tooth that substantially fractures the web. For instance, in one known blade, the teeth are formed by punching a conical forming element entirely through the web so that the forming element bursts through the web to forming a series of shards or teeth that curve upwardly and outwardly away from one another. When forming the teeth, the forming tool is displaced through the web so that the tip of the forming tool projects at or above the height of the tooth. In other words, the tip of the tool projects from the web a distance that is larger than the height of the tooth. Similarly, in U.S. Pat. No. 6,491,198 the teeth are punched through the web in a triangular shape, so that substantially the entire cutting surface is sheared from the web.

In contrast, in the present instance, the teeth may be formed by displacing the web upwardly to form a protrusion that is formed significantly by deformation rather than punching through the web. Specifically, the forming element may be displaced into the web a sufficient distance to deform the tooth without piercing the web. In this regard, the forming element is displaced into the web so that the tip of the tool does not project beyond the highest point of the tooth. However, the forming tool may sufficiently deform the protrusion upwardly such that the tip of the protrusion cracks or fractures. In other words, each tooth may comprise a base portion that is substantially conical or pyramidal and a tip that is fractured to form one or more edges, as shown in FIGS. 4-6. Additionally, as shown in FIGS. 4 and 6, the teeth may be formed so that the fractures form one or more hooded elements, similar to a clam shell. The fractures may form elements that are curved toward the center of the tooth or toward another portion(s) of the tooth.

It will be recognized by those skilled in the art that changes or modifications may be made to the above-described embodiments without departing from the broad inventive concepts of the invention. For instance, although the above description describes the cutting blade as having a pair of spaced apart rows of teeth along edges of the cutting blade, the cutting blade may only have a single row of teeth, and the single row may be formed along an edge of the web or it may be formed along the center of the web. Further, although the cutting blade has been described as having two rows of teeth that are formed to be substantially similar, the cutting blade may be formed so that one row of teeth projects upwardly to a height that is greater than the height of the teeth in the second row. For instance, one row of teeth may be formed as described above, while a second row of teeth may be formed so that the teeth are shorter (e.g. less than 0.010″). Further, the shorter row of teeth may be formed so that the teeth are substantially intact protrusions with minimal cracks. In other words, the shorter teeth may be substantially void of cracks that would form an edge.

It should therefore be understood that this invention is not limited to the particular embodiments described herein, but is intended to include all changes and modifications that are within the scope and spirit of the invention as set forth in the claims.

What is claimed is:

1. A cutting blade for cutting sheet wrapping materials, comprising:
a longitudinally elongated web having a length;
a row of microteeth extending along the length of the web, wherein the microteeth project upwardly from the web less than approximately 0.015″; and
a generally vertical leg connected with the web projecting downwardly from the web for connecting the blade to a substrate.

2. The cutting blade of claim 1 wherein the microteeth project upwardly from the web at least approximately 0.010.

3. The cutting blade of claim 1 wherein each of the microteeth comprises a cutting surface disposed transverse the longitudinal axis of the web.

4. The cutting blade of claim 1 wherein the microteeth are separated from one another by approximately 0.025″ to approximately 0.100″.

5. The cutting blade of claim 1 wherein the microteeth are separated from one another by approximately 0.025″ to approximately 0.075″.

6. The cutting blade of claim 1 wherein the microteeth are separated from one another by less than approximately 0.050″.

7. The cutting blade of claim 1 wherein the web comprises an elongated edge and the row of microteeth are positioned adjacent the edge.

8. The cutting blade of claim 8 wherein the web comprises a second elongated edge and the cutting blade comprises a second row of microteeth projecting upwardly from the web adjacent the second elongated edge.

9. The cutting blade of claim 8 wherein the elongated edge is formed by the intersection of the web and the generally vertical leg.

10. The cutting blade of claim 1 wherein the cutting blade comprises a second generally vertical leg spaced apart from the first generally vertical leg to provide a pair of opposing legs, wherein the terminal end of each leg curves inwardly toward the opposing leg to create gripping ends for retaining the cutting blade on a substrate.

11. A cutting blade for cutting sheet wrapping materials, comprising:
a longitudinally elongated web having a length;
a generally vertical leg connected with the web projecting downwardly from the web for connecting the blade to a substrate;
an elongated edge formed by the intersection of the web and the generally vertical leg; and
a row of surface irregularities extending along the web adjacent the elongated edge.

12. The cutting blade of claim 12 wherein the surface irregularities project upwardly from the web approximately 0.005″ to 0.015″.

13. The cutting blade of claim 11 wherein the surface irregularities project upwardly from the web approximately 0.008″ to 0.015″.

14. The cutting blade of claim 12 wherein the surface irregularities are longitudinally aligned along the length of the web.

15. The cutting blade of claim 12 wherein the surface irregularities are formed by piercing through the thickness of the web.

16. The cutting blade of claim 12 wherein the surface irregularities are spaced apart from one another along the length of the web.

17. The cutting blade of claim 11 wherein the cutting blade comprises a second generally vertical leg spaced apart from the first generally vertical leg to provide a pair of opposing legs, wherein the terminal end of each leg curves inwardly toward the opposing leg to create gripping ends for retaining the cutting blade on a substrate.

18. A method for cutting sheet material, comprising:
providing a cutting blade having a generally horizontal longitudinally elongated web, and elongated edge along the length of a side of the web, and a row of surface irregularities extending along the elongated edge; attaching the cutting blade to a substrate;
pulling a length of sheet material over the cutting blade to from a roll of sheet material;
pulling the sheet material against the surface irregularities and the elongated edge to cut the length of sheet material from the roll.

19. The method of claim 18 wherein the step of providing a cutting blade comprises forming the surface irregularities in the web so that the surface irregularities project upwardly from the web approximately 0.005″ to 0.020″.

20. The method of claim 18 wherein the step of forming the surface irregularities comprises piercing the web.

21. The method of claim 18 wherein the step of forming the surface irregularities comprises roll forming the surface irregularities along the length of the web.

22. The method of claim 18 wherein the step of forming the surface irregularities comprises punching the surface irregularities into the web.

23. A method for producing a cutting blade for cutting sheet material, comprising the steps of:
forming an elongated strip of metal;
providing a forming element comprising one or more tips having an end;
using the forming element to form a plurality of teeth in a row in the strip of metal, wherein the step of forming the teeth comprises the steps of:
displacing the end of the tip toward the metal strip so that the tip deforms the metal to form a protrusion;
continuing displacement of the tip toward the metal so that a portion of the protrusion cracks to form an edge;
limiting the displacement of the forming element toward the metal so that the end of the protrusion protrudes from the strip further than the end of the tip of the forming element.

24. The method of claim 23 comprising the step of folding the metal to form an top surface and a leg, wherein the leg is operable to mount the cutting blade on a substrate.

25. The method of claim 23 comprising the step of folding the metal strip to form an edge and the row of teeth are formed along the edge.

26. The method of claim 23 wherein the step of forming the teeth comprises displacing the tip of the forming element toward the metal so that the teeth project from the metal strip a height of less than 0.015″.

27. The method of claim 26 wherein the teeth project from the strip a height of less than 0.010″.

28. The method of claim 26 where in the teeth project from the strip a height of approximately 0.005″ to approximately 0.010.

29. A cutting blade for cutting sheet material, comprising:
an elongated web;
a leg for attaching the cutting blade to a substrate;
a row of teeth, wherein each tooth comprises a curved cutting element curving toward a central portion of the tooth.

30. The cutting blade of claim 29 wherein the curved cutting element comprises a hooded shaped element.

31. The cutting blade of claim 29 wherein each tooth comprises a:
generally conical shaped protrusion protruding upwardly from a surface of the web; and
a fractured tip forming the cutting element.
